(19) United States
(12) Patent Application Publication
(10) Pub. No.: US 2009/0296722 A1
(43) Pub. Date: Dec. 3, 2009

(54) Modular power line repeater and system

(75) Inventors: Frank Lai, Nashua, NH (US); Hong Yu, Hollis, NH (US)

Correspondence Address: Joanne M. Martin, 40 North Spring Street, Concord, NH, 03301-3902, US

(73) Assignee: Aboundi, Inc.

(21) Appl. No.: 12/156,418

(22) Filed: Jun. 2, 2008

(51) Int. Cl. H04L 12/56

(52) U.S. Cl. 370/401

(57) ABSTRACT

A data router or data switch connected to a medium and having private addresses bounded to a specific subsegment of and address range, and a user-selectable number of data repeaters also connected to the medium in a sequence of overlapping address ranges, in which a data repeater communicates upstream with a prior data repeater (or if it is the first repeater, the data router) and provides a data path to subsequent data repeaters over a different subsegments of that range by address translation, permitting extension of the usable range of the resulting network without the need for data-blocking filters on the medium, and without interference generated by the repeaters.

### FIELD OF THE INVENTION

The present invention relates to network data systems and associated distribution devices, and in particular to data repeaters and resulting systems providing data transfer over building infrastructure connections such as non-data signal lines, non-data control lines and power mains.

### BACKGROUND OF THE INVENTION

Data transmission over media not originally intended for data transfer, e.g. 120V/208V/240V/etc. AC building power mains generally requires a data router or data switch which receives data from external (e.g. DSL or cable modem internet connection) or other internal building data sources, and includes a medium (e.g. power mains) interface in order to properly propagate and receive a bi-directional data flow over that medium. A user connects a corresponding medium interface which provide a bi-direction data connection between the user equipment (e.g. a computer) and the data path signals on the medium. After initially connecting, the user's equipment obtains a private IP address either by dynamic (e.g. DHCP) or manual assignment, and data transfer proceeds.

However, the success of such implementations will result in many such connections, often over the same or adjacent power circuits. Often a particular path between user interface and data router interface become corrupted, interrupted or extended, which results in a new path being dynamically established or loss of the data path if the path routing is fixed.

A further problem occurs as the distance between the router interface and the user interface increases in distance, or has an interference source imposed on it, effectively decreasing the medium data signal-to-noise ratio. The application of a signal regenerating repeater on the medium between the router interface and the user interface would require the further interruption of the medium and the insertion of some sort of filter to isolate the portion of the medium between the router interface and the regenerating repeater, and between the portion of medium between the regenerating repeater and the user interface. If the medium is a room power mains, this is generally not feasible, and one is left to reposition the router interface, the user interface, or to locate isolate each offending noise sources, if possible. Otherwise, the medium data transfer system is abandoned and dedicated cables are run.

### SUMMARY OF THE INVENTION

The present invention comprises a data router/switch connected to a medium which may have a non-[TCP/IP addressed] data purpose, e.g. a AC power mains, HVAC or other building control, analog signal line, etc., the data router/switch having private addresses bounded to a specific subsegment of and address range, and a user-selectable number of data repeaters also connected to the medium in a sequence of different TCP/IP address ranges, in which a data repeater communicates upstream with a prior data repeater (or if it is the first repeater, the data router) and provides a data path to subsequent data repeaters over a different subsegments of that range by address translation, permitting extension of the usable range of the resulting network without the need for data-blocking filters on the medium, and without interference generated by the repeaters, which are typically layer 1 and/or layer 2 repeaters. Moreover, the selective limitation of the address range subsegments to a controlled and selected subsegment range effectively manages the data system thus formed to remain within a selected environment (e.g. a selected number of power mains circuit paths) rather than an unrestricted data structure that could otherwise arise if medium conditions (e.g. due to interference, etc.) substantially change.

Embodiments further include the methods of extending data network range by translated address repeating as described herein.

### BRIEF DESCRIPTION OF THE DRAWING

These and further features of the present invention will be better understood by reading the following Detailed Description together with the Drawing, wherein

FIG. 1 is a block diagram of a typical physical arrangement of a system according to the present invention;

FIG. 2 is a block diagram of a typical logical deployment of an embodiment according to the present invention; and

FIG. 3 is a block diagram of a repeater according to one embodiment of the present invention.

### DETAILED DESCRIPTION OF AN EXEMPLARY EMBODIMENT

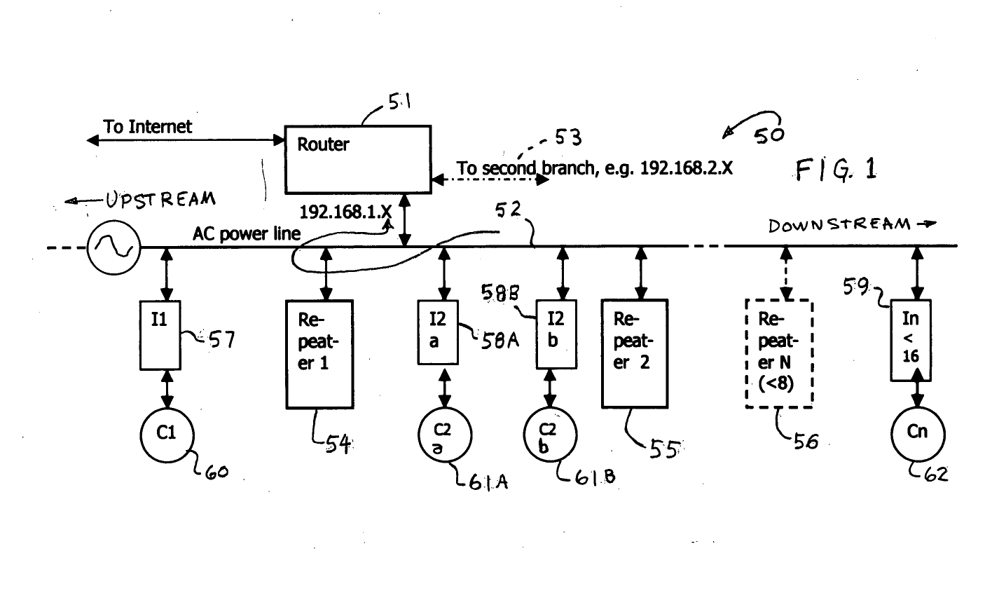

As shown in an exemplary embodiment 50 of FIG. 1, a data system, e.g. internet, is connected to a router 51 which provides data to a medium, e.g. an AC power mains 52 via an internal data-to-medium converter (not shown) having a private IP address in a specific range, e.g. 192.168.1.X where X is restricted to a first subsegment defined below. At least one additional branch 53 is optionally provided to communicate with other medium, and having a different private address, e.g. 192.168.2.X, and also having a private IP address restricted to its own first subsegment range.

User equipment 60 connected to network and medium interface 57, typically in proximity to the router 51 communicates directly with the router 51 with a private IP address in a first subsegment range. More distant user equipment 61A and 61B communicate with the router 51 on the medium 52 via a first repeater 54 with a private IP address in a second address range subsegment, which is translated to a data channel with said router within the first address subsegment ranges. Further repeater 55 is located still more distant from the router 51 and receives data communication from any user equipment and interfaces connected at that location at a third address range subsegment, which in turn includes data communication up to a maximum repeater N, 56 which provides communication with user equipment 62 via interface 59 to the router via medium 52 and data transfer and translation through all prior repeaters, e.g. 55, 54. Typically, the interface units 59, and 58A, 58B receive their dynamically selected IP address from ‘their’ repeater 55 and 54 respectively (and interface 57 from the router 51), but the IP address may be manually selected by the interfaces (typically under control of the connected user equipment) to the an upstream repeater, router or even a downstream repeater as may be desired for a particular reason.

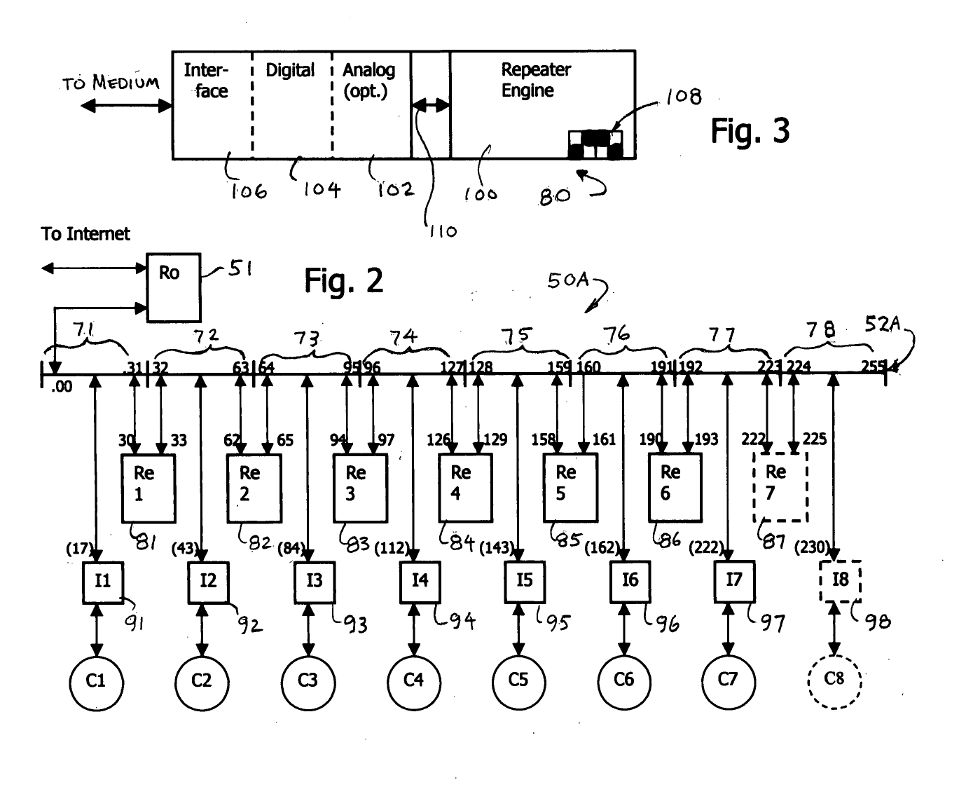

According to one embodiment of the present invention, the above exemplary system 50 is logically dividable as shown in the diagram 50A of FIG. 2. The medium 51A is shown with the least significant 8 bits (LSB) or host portion of the private IP address as having 8 distinct subsegments of equal numbers within a range of 0-255, such that a first subsegment 71 has an address subsegment in the range of 00-31, the second subsegment 72 has an address subsegment in the range of 32-63, and so forth until the eight and last subsegment 78 has an address subsegment in the range of 224-255. The router 51 communicates with repeaters and interfaces in the private IP address subsegment of 00-31, which can address at least 15 user equipment interfaces directly, or fewer user equipment interfaces directly and more through the one or more intervening repeaters, of which one repeater communicates in that same 00-31 address subsegment.

With regard to the use of subnet masks in the exemplary interface units 91-98, the subnet mask of 255.255.255.224 permits a system 50A to comprise 8 subsegments, while a subnet mask of 255.255.255.192 permits an alternate system to have 4 subsegments (while increasing the number of interface addresses within each subsegment from a theoretical maximum of 32 (ignoring reserved numbers) to 64 as 1 more bit is no longer masked. Thus the total network address includes the most significant 24 bits (the left-most 255.255.255 part) and next number of bits also masked. The exemplary embodiment provides the next number of bits=3, but alternate embodiments include other total number of bits available for the network address. An exemplary system 50A comprises a router 51, seven repeaters 81-87 providing 8 IP address subsegments.

The typical repeater 80 is shown in FIG. 3. including a repeater engine 100 having a digital signal format (e.g. voltage levels, etc.) communicating through a layer 1 and layer 2 digital interface processor 102 to place the signal in a format for passage over a selected medium, e.g. the power mains 52, and an interface 106 to provide the desired voltage, waveforms, isolation, etc. for safe and reliable data connection to the selected medium. Alternate embodiments provide a repeater engine 100 which is separable from the digital interface processor 102 and which communicates via other connections (e.g. RJ45, twisted pair, etc.) and requires analog conditioning prior to the digital interface processor as provided by analog front end 102 connected to the repeater engine. Physical layer circuitry including interface and digital elements 106 and 104 are typically provided by 3rd parties, e.g. the INT5500 integrated circuit set by Intellon and others, may be used. A feature according to the present invention provides a single level 1/level 2 (or equivalent) digital interface to the medium 52, since the upstream or downstream direction of communications is communicated via the same medium.

The repeater engine 100 when powered up, it establishes 2 IP addresses (e.g. 30, 33), based on the switch 108 position (e.g. 0001) and the repeater provide addresses for ‘downstream’ interface units via DHCP protocol. The repeater position is determined by the setting of a switch 108 located on each repeater and typically detected upon power-up, which may be manually set to a number indicating the position in a sequence of 1-7. In the present embodiment, the router is assigned the equivalent of a sequence position of 0, and the first repeater added is assigned a number of 1, and subsequently added repeaters are sequentially incremented in number until 7, the final available repeater number.

A further feature according to one embodiment of the present invention allows a specific repeater, e.g. the 5th repeater (85) to ‘give out’ IP addresses that it is “in charge of”, e.g. segment 6 (76). When a dynamic address method is used, the user equipment interface (e.g. 94) will select an IP address among multiple DHCP (IP address) offers by data repeaters, typically the nearby repeaters (e.g. 83, 84, 86). Thus the 5th repeater (85) selects an IP address from among the IP addresses (e.g. .160-.191 excluding reserved addresses) offered by nearby repeaters.

A first repeater 81 (switch set to ‘1’) is also assigned an IP address, e.g. 192.186.1.30, within the first subsegment 71 range of 00-31 to communicate with the addresses of prior subsegment connected interfaces. The first repeater is also assigned with an IP address, e.g. 192.168.1.33, in order to communicate with the addresses of subsequently connected interfaces, e.g. 92, and a subsequently connected second repeater 82 within the second subsegment 72 range 32-63 (excepting reserved addresses, if any), the second repeater being defined by a switch set to ‘2’.

The manner of IP address assignment continues in sequence according the switch numbers, such that repeaters communicate with other repeaters only according to address ranges associated with the switch number value. Any repeater with a switch set to a specific number communicates with the upstream (closer to the router 51) by the shared subsegment and any user equipment by interfaces also associated with that subsegment. For instance, the fifth interface 95 communicates with the internet first via the fourth repeater 84 over shared fifth subsegment 75, which fourth repeater communicates with the third repeater 83 over shared fourth subsegment 74, which third repeater communicates with the second repeater 82 over shared third subsegment 73, which second repeater 82 communicates over with the first repeater 81 over the second subsegment 72, which first repeater 81 communicates with the router 51 over the first subsegment 71, which router 51 communicates to the outside network (e.g. internet, layer 3 ethernet port, etc.). If the fifth interface 95 communicates with the second interface 92, the process would be analogous, except that the second repeater 82 would communicate with the second interface 92 (instead of the first repeater 81) over the second subsegment 72. An analogous process occurs when a user equipment, via the corresponding interface, communicates with a downstream (farther away from the router 51) via higher numbered repeaters and higher numbered subsegments.

When data is passed through the individual repeater, data blocks are retained intact, and only the incoming and outgoing addressing is changed. The protocol for addressing between interface units (e.g. 91-98) and between interface units and repeaters (e.g. 81-87) or the router 51 is provided by and is modified according the present invention wherein the binary values of the private IP address bits more significant than the number of bits used for the subsegment range correspond to the switch 108 setting. For instance, a 32 address subsegment range corresponds to the 5 least-significant IP address bits, so the “more significant bits” would begin with the next most significant bits (6th, 7th and 8th for an address range of 8 subsegments) each bit set on or off according to positions of individual bit toggles within the switch 108. The present invention selectively offsets, e.g. adds (or subtracts “1” in this example) for the upstream subsegment communication different from the downstream subsegment communications. Other embodiments may choose different offsets, and may further choose allocate non-contiguous subsegments.

Exemplary Tables 1, 2 and 3, below, describe an implementation for the particular data format, data equipment, repeaters and routers used. Gateway addresses are the addresses of the repeaters themselves, having at least one address and in alternate embodiments, two or more addresses. Alternate embodiments using different data format, data equipment, repeaters and routers, or equivalents thereof, are operable in an analogous or equivalent manner.

TABLE 1

| | | |
|---|---|---|
| Destination | Gateway | NetMask |

Repeater 1 (Switch = 1) routing table:

| | | |
|---|---|---|
| 192.168.1.0 | * | 255.255.255.224 |
| 192.168.1.32 | * | 255.255.255.224 |
| 192.168.1.64 | 192.168.1.62 | 255.255.255.192 |
| 192.168.1.128 | 192.168.1.62 | 255.255.255.128 |
| Default | 192.168.1.1 | 0.0.0.0 |

The above routing table is equivalent to:

| | | |
|---|---|---|
| 192.168.1.0 | * | 255.255.255.224 |
| 192.168.1.32 | * | 255.255.255.224 |
| 192.168.1.64 | 192.168.1.62 | 255.255.255.224 |
| 192.168.1.96 | 192.168.1.62 | 255.255.255.224 |
| 192.168.1.128 | 192.168.1.62 | 255.255.255.224 |
| 192.168.1.160 | 192.168.1.62 | 255.255.255.224 |
| 192.168.1.192 | 192.168.1.62 | 255.255.255.224 |
| 192.168.1.224 | 192.168.1.62 | 255.255.255.224 |
| Default | 192.168.1.1 | 0.0.0.0 |

The above exemplary Repeater 1 routing table dictates:

1. If this repeater receives a packet and needs to send to 192.168.1.0 to 192.168.1.31 (subsegment 1), it should just be sent out, because the repeater 1 actually sits between segment 1 and segment 2, and is capable of communicating directly to user equipment interface in subsegment 1.

2. If this repeater receives a packet and needs to send to 192.168.1.32 to 192.168.1.63 (subsegment 2), it should just be sent out, because the repeater 1 actually sits between segment 1 and segment 2, and is capable of communication directly to the user equipment interface in subsegment 2.

3. If this repeater receives a packet and needs to send to 192.168.1.64 to 192.168.1.95 (subsegment 3), it should just be sent to repeater 2 IP address 192.168.1.62.

4. If this repeater receives a packet and needs to send to 192.168.1.96 to 192.168.1.127 (subsegment 4), it should just be sent to repeater 2 IP address 192.168.1.62.

5. If this repeater receives a packet and needs to send to 192.168.1.128 to 192.168.1.159 (subsegment 5), it should just be sent to repeater 2 IP address 192.168.1.62.

6. If this repeater receives a packet and needs to send to 192.168.1.160 to 192.168.1.191 (subsegment 6), it should just be sent to repeater 2 IP address 192.168.1.62.

7. If this repeater receives a packet and needs to send to 192.168.1.192 to 192.168.1.223 (subsegment 7), it should just be sent to repeater 2 IP address 192.168.1.62.

8. If this repeater receives a packet and needs to send to 192.168.1.224 to 192.168.1.255 (subsegment 8), it should just be sent to repeater 2 IP address 192.168.1.62.

9. If this repeater receives a packet and needs to send any address that not in the above range, it should just be sent it to 192.168.1.1 (default).

Note that 192.168.1.1 is the interface address of the internet Router (Repeater 0), and 192.168.1.62 is one of the interface addresses of repeater 2.

TABLE 2

| | | |
|---|---|---|
| Destination | Gateway | NetMask |

Repeater 2 (Switch = position 2) routing table:

| | | |
|---|---|---|
| 192.168.1.32 | * | 255.255.255.224 |
| 192.168.1.64 | * | 255.255.255.224 |
| 192.168.1.96 | 192.168.1.94 | 255.255.255.224 |
| 192.168.1.128 | 192.168.1.94 | 255.255.255.128 |
| Default | 192.168.1.33 | 0.0.0.0 |

The above exemplary Repeater 2 routing table is equivalent to:

| | | |
|---|---|---|
| 192.168.1.0 | 192.168.1.33 | 255.255.255.224 |
| 192.168.1.32 | * | 255.255.255.224 |
| 192.168.1.64 | * | 255.255.255.224 |
| 192.168.1.96 | 192.168.1.94 | 255.255.255.224 |
| 192.168.1.128 | 192.168.1.94 | 255.255.255.224 |
| 192.168.1.160 | 192.168.1.94 | 255.255.255.224 |
| 192.168.1.192 | 192.168.1.94 | 255.255.255.224 |
| 192.168.1.224 | 192.168.1.94 | 255.255.255.224 |
| Default | 192.168.1.33 | 0.0.0.0 |

The Repeater 2 routing table dictates:

1. If this repeater receives a packet and needs to send to 192.168.1.0 to 192.168.1.31 (subsegment 1), it should just be sent to 192.168.1.33.

2. If this repeater receives a packet and needs to send to 192.168.1.32 to 192.168.1.63 (subsegment 2), it should just be sent out, because the repeater 2 actually sits between segment 2 and segment 3, and is capable of communicating directly to the user equipment interface in subsegment 2.

3. If this repeater receives a packet and needs to send to 192.168.1.64 to 192.168.1.95 (subsegment 3), it should just be sent out, because the repeater 2 actually sits between segment 2 and segment 3, and is capable of communicating directly to user equipment in subsegment 3.

4. If this repeater receives a packet and needs to send to 192.168.1.96 to 192.168.1.127 (subsegment 4), it should just be sent to repeater 3 IP address 192.168.1.94.

5. If this repeater receives a packet and needs to send to 192.168.1.128 to 192.168.1.159 (subsegment 5), it should just be sent to repeater 3 IP address 192.168.1.94.

6. If this repeater receives a packet and needs to send to 192.168.1.160 to 192.168.1.191 (subsegment 6), it should just be sent to repeater 3 IP address 192.168.1.94.

7. If this repeater receives a packet and needs to send to 192.168.1.192 to 192.168.1.223 (subsegment 7), it should just be sent to repeater 3 IP address 192.168.1.94.

8. If this repeater receives a packet and needs to send to 192.168.1.224 to 192.168.1.255 (subsegment 8), it should just be sent to repeater 3 IP address 192.168.1.94.

9. If this repeater receives a packet and needs to send any address that not in the above range, it should just be sent to 192.168.1.33 (default).

Note that 192.168.1.94 is one of the interface addresses of repeater 3, and that 192.168.1.33 is one of the interface addresses of repeater 1.

TABLE 3

| | | |
|---|---|---|
| Destination | Gateway | NetMask |

Repeater 7 (Switch Position = 7) routing table:

| | | |
|---|---|---|
| 192.168.1.192 | * | 255.255.255.224 |
| 192.168.1.224 | * | 255.255.255.224 |
| Default | 192.168.1.193 | 0.0.0.0 |

The above routing table is equivalent to:

| | | |
|---|---|---|
| 192.168.1.0 | 192.168.1.193 | 255.255.255.224 |
| 192.168.1.32 | 192.168.1.193 | 255.255.255.224 |
| 192.168.1.64 | 192.168.1.193 | 255.255.255.224 |
| 192.168.1.96 | 192.168.1.193 | 255.255.255.224 |
| 192.168.1.128 | 192.168.1.193 | 255.255.255.224 |
| 192.168.1.160 | 192.168.1.193 | 255.255.255.224 |
| 192.168.1.192 | * | 255.255.255.224 |
| 192.168.1.224 | * | 255.255.255.224 |
| Default | 192.168.1.193 | 0.0.0.0 |

The above exemplary Repeater 7 routing table dictates:

1. If this repeater receives a packet and needs to send to 192.168.1.192 to 192.168.1.223 (subsegment 6), it should just be sent out, because the repeater 7 actually sits between segment 7 and segment 8, and is capable of communicating directly to the user equipment interface in subsegment 9.

2. If this repeater receives a packet and needs to send to 192.168.1.224 to 192.168.1.255 (subsegment 7), it should just be sent out, because the repeater 7 actually sits between segment 7 and segment 8, and is capable of communicating directly to the user equipment interface in subsegment 9.

3. If this repeater receives a packet and needs to send any address that not in the above range, it should just be sent to repeater 6 IP address 192.168.1.193 (default).

Routing tables for repeaters 3-6 (not shown) are analogous to the routing tables for the above repeaters 1, 2 and 7.

Alternate embodiments may include subsegments defined in a different sequence, e.g. beginning from the highest address (e.g 255) or other numerical ordering. Other implementations arising from the evolution of the TCP/IP and DHCP are within the scope of the present invention. Further modifications and substitutions according to one skilled in the art are within the scope of the present invention which is not to be limited except by the claims which follow.

What is claimed is:

1. An extendable data distribution system communicating with an external data network, comprising:
a data media having a data continuity over a length thereof and adapted to provide non-data transfer over at least a portion thereof;
an external data network interface connected to said external data network and to said data media, including a private IP address generator having a first subsegment address; and
a data media repeater connected to said external data network and providing data transfer with said external data network interface in response to said first subsegment address and providing corresponding data transfer to said data media at a second subsegment address.

2. The extendable data distribution system of claim 1, further including an end-user interface connected to said data media responsive to said data media repeater second subsegment address.

3. The extendable data distribution system of claim 1, further including a plurality of media repeaters each having a different range of subsegment addresses from other media repeaters of said plurality of media repeaters.

4. The extendable data distribution system of claim 3, wherein said each of different range of subsegment addresses comprises an address range contiguous with said media repeater preceding along said data media to said external data network interface.

5. The extendable data distribution system of claim 3, wherein said plurality of media repeaters comprise media repeaters adapted to communicate with selected medium address subsegments selected in response to a switch having a corresponding switch position.

6. The extendable data distribution system of claim 5, wherein
said address subsegments comprise selected TCP/IP addresses, and
said switch comprises a switch located in each media repeater operable to provide selected TCP/IP address ranges for the media repeater in which the switch is located.

7. The extendable data distribution system of claim 1, wherein said data media repeater includes a single layer 1 and corresponding single layer 2 interface in bidirectional communication with medium connected equipment having at least two subsegments.

8. The extendable data distribution system of claim 1, wherein said medium comprises a building infrastructure connection.

9. The extendable data distribution system of claim 8, wherein said building infrastructure connection comprises an AC power mains.

10. An extendable data distribution system, comprising:
a data media having a data continuity over a length thereof; and
a data media repeater connected to said data media and providing data transfer in response to a data address within a first range of data addresses into data having a data address in a second range of data addresses onto said data media.

11. The extendable data distribution system of claim 10, wherein said data media comprises one of a power mains, non-data signal lines and non-data control lines.

12. The extendable data distribution system of claim 10, wherein said data media repeater is a bi-directional data repeater providing data transfer in response to a data address within said second range of data addresses into data having and address in said first range of data addresses onto said data media.

13. The extendable data distribution system of claim 10, further including a plurality of data media repeaters each having two selectable ranges of associated data addresses including a first associated address range in which a selected one of the media repeater receives data and a second associated address range into which said received data is transmitted, wherein said first associated address range of one repeater overlaps said second associated address range of another repeater, and wherein one of said plurality of repeaters said first and said second associated addresses corresponds to said data media repeater first and second range of addresses.

14. The extendable data distribution system of claim 13, wherein said first associated address range of one media repeater overlaps an other said second associated address range of said other media repeater to permit data communication between said one media repeater and said other of said media repeater.

13. The extendable data distribution system of claim 10, wherein said data media repeater is bidirectional further providing data transfer in response to a data address within said second range of data addresses into data having a data address in said first range of data addresses onto said data media.

14. The extendable data distribution system of claim 10 wherein said data media repeater data address ranges are manually selectable.

15. The extendable data distribution system of claim 14, wherein said manually selectable address ranges comprises TCP/IP address ranges selectable according to a switch associated with each data media repeater.

16. A method of extendable data distribution, comprising:
placing data having a selected first address range on a medium;
repeating said first address range data at a second address range along said medium.

17. The method of claim 16, wherein placing data comprises
placing data on one of a power main, non-data signal line and non-data control line.

18. The method of claim 16, further including
repeating said second address range of data at as data having a third address range along said medium.

19. The method of claim 18, wherein
placing data comprises placing data from a source located along said medium having a selected first address range on a medium, and
repeating said second address range comprises repeating distal from said source said second address range of data comprises repeating said second address range of data at as data having a third address range along said medium.

20. The method of claim 16, wherein repeating includes manually selecting at least one of said first and said second address ranges.
